(19) United States
(12) Patent Application Publication
(10) Pub. No.: US 2024/0302049 A1
(43) Pub. Date: Sep. 12, 2024

(54) SUPPLY SYSTEM AND HYDROGEN COOKING SYSTEM

(71) Applicant: TOYOTA JIDOSHA KABUSHIKI KAISHA, Toyota-shi (JP)

(72) Inventors: Masashi NAKAMURA, Toyota-shi (JP); Masahiro Iwamoto, Nisshin-shi (JP); Takao Kataoka, Nagoya-shi (JP); Tomoki Nakashima, Nagoya-shi (JP)

(73) Assignee: TOYOTA JIDOSHA KABUSHIKI KAISHA, Toyota-shi (JP)

(21) Appl. No.: 18/439,980

(22) Filed: Feb. 13, 2024

(30) Foreign Application Priority Data
Mar. 10, 2023 (JP) 2023-038128

(51) Int. Cl. F24C 1/04; F24C 3/12; F24C 3/14; F24C 15/00; F24C 15/20; F24C 3/02; F24C 15/02; F24C 15/12

(52) U.S. Cl. CPC F24C 1/04; F24C 3/124; F24C 3/14; F24C 15/006; F24C 15/2035; F24C 3/027; F24C 15/024; F24C 15/12

(57) ABSTRACT

A supply system includes a hydrogen module and a fuel cell module. The hydrogen module includes a portable first housing, which includes at least one wheel, and at least one hydrogen cartridge housed in the first housing. The fuel cell module includes a portable second housing, which includes least one wheel, and a fuel cell housed in the second housing. The fuel cell module and the hydrogen module are mechanically and electrically connected. The fuel cell is capable of generating electric power from hydrogen gas supplied by the hydrogen module.

### CROSS-REFERENCE TO RELATED APPLICATION

This application claims priority to Japanese Patent Application No. 2023-038128 filed on Mar. 10, 2023, the entire contents of which are incorporated herein by reference.

### TECHNICAL FIELD

The present disclosure relates to a supply system and a hydrogen cooking system.

### BACKGROUND

Technology for supplying fuel is known. For example, Patent Literature (PTL) 1 discloses a fuel cell fuel cartridge that supplies fuel to a fuel cell.

### CITATION LIST

### Patent Literature

PTL 1: JP 2007-200734 A

### SUMMARY

Environmental concerns have led to a growing interest in hydrogen cookers. To increase the flexibility of where hydrogen cookers can be used, it is desirable to improve the portability of the supply system that supplies fuel to the hydrogen cookers.

It would be helpful to improve the portability of a supply system.

A supply system according to an embodiment of the present disclosure includes a hydrogen module including a portable first housing and at least one hydrogen cartridge housed in the first housing, the first housing including at least one wheel, and a fuel cell module including a portable second housing and a fuel cell housed in the second housing, the second housing including at least one wheel. The fuel cell module and the hydrogen module are mechanically and electrically connected. The fuel cell is capable of generating electric power from hydrogen gas supplied by the hydrogen module.

A hydrogen cooking system according to an embodiment of the present disclosure includes the aforementioned supply system and a cooking system. The cooking system includes a first cooker capable of heating and cooking by electric power supplied by the supply system, a pressure reducing valve configured to reduce pressure of hydrogen gas supplied by the supply system to a predetermined pressure, and a second cooker capable of heating and cooking by burning hydrogen gas whose pressure has been reduced by the pressure reducing valve.

According to an embodiment of the present disclosure, the portability of a supply system can be improved.

### BRIEF DESCRIPTION OF THE DRAWINGS

In the accompanying drawings:

FIG. 1 is a diagram illustrating a schematic configuration of a hydrogen cooking system according to an embodiment of the present disclosure;

FIG. 2 is a view of the hydrogen cooking system, illustrated in FIG. 1, from behind;

FIG. 3 is a block diagram of the hydrogen cooking system illustrated in FIG. 1;

FIG. 4 is a diagram illustrating the external configuration of a hydrogen module and a fuel cell module illustrated in FIG. 1;

FIG. 5 is an example of use of the hydrogen module illustrated in FIG. 4;

FIG. 6 is a block diagram of the hydrogen module illustrated in FIG. 4;

FIG. 7 is a view of the fuel cell module, illustrated in FIG. 4, from behind;

FIG. 8 is a block diagram of the fuel cell module illustrated in FIG. 4; and

FIG. 9 is a diagram illustrating the external configuration of hydrogen modules according to a variation of the present disclosure.

### DETAILED DESCRIPTION

An embodiment of the present disclosure will be described below, with reference to the drawings.

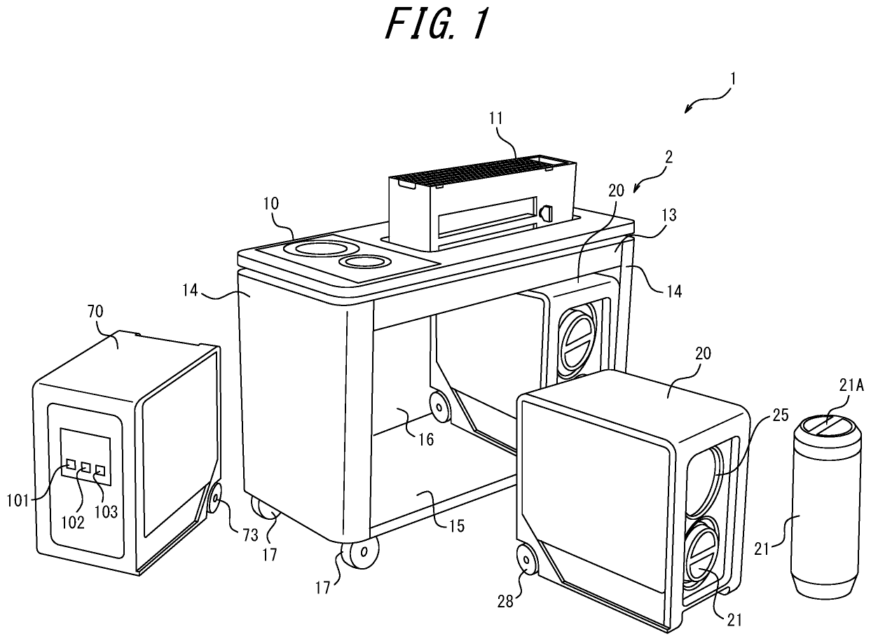

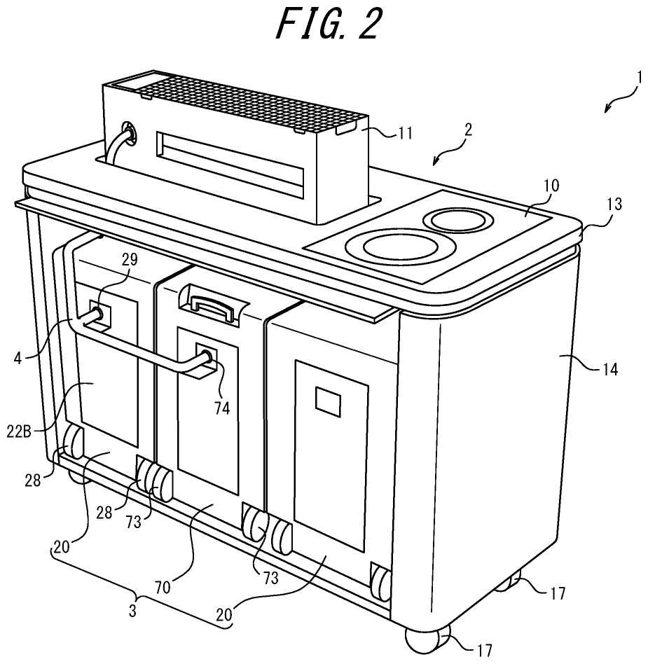

A hydrogen cooking system 1 according to the present embodiment, as illustrated in FIG. 1, may be used in any location, such as outdoors. As illustrated in FIG. 2, the hydrogen cooking system 1 includes a cooking system 2 and a supply system 3. FIG. 2 illustrates hydrogen modules 20 and a fuel cell module 70, described below, housed in the cooking system 2.

### Configuration of Cooking System

Users can use the cooking system 2 to cook food. The cooking system 2 is supplied with hydrogen gas and electric power from the supply system 3 via piping 4, as illustrated in FIG. 2. The piping 4 may be made from any metallic material. The piping 4 includes, for example, three ends. However, the piping 4 may include any number of ends, depending on the configuration of the hydrogen cooking system 1.

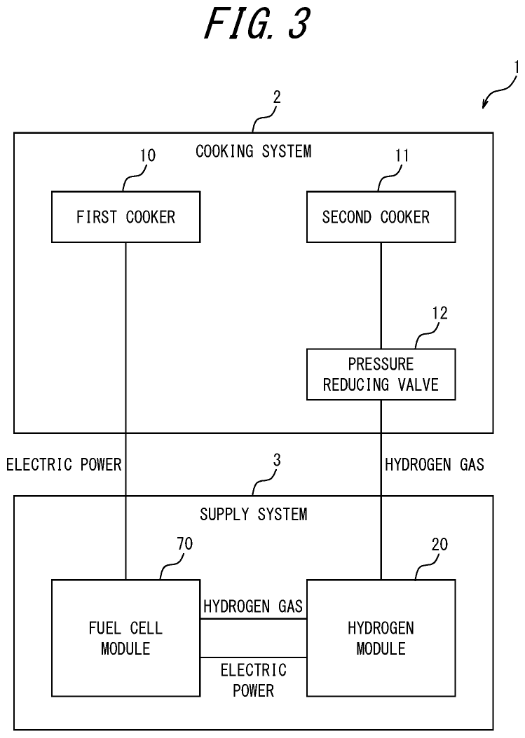

As illustrated in FIG. 1, the cooking system 2 includes a first cooker 10, a second cooker 11, a cooking table 13, two legs 14, a plate 15, a storage 16, and four wheels 17. As illustrated in FIG. 3, the cooking system 2 includes a pressure reducing valve 12. In the present embodiment, the cooking system 2 includes four wheels 17. However, it suffices for the cooking system 2 to include at least one wheel 17, depending on factors such as the shape of the cooking table 13.

The first cooker 10 is supplied with electric power from the supply system 3, as illustrated in FIG. 3. The first cooker 10 is capable of heating and cooking by electric power. The first cooker 10 may be any cooker, as long as it is capable of heating and cooking by electric power. The first cooker 10 is, for example, an induction cooker or an electric cooker. Examples of electric cookers include hot plates, electric rice cookers, and steam convection ovens. As illustrated in FIG. 1, the first cooker 10 is placed on the cooking table 13. The first cooker 10 may be integrated into the cooking table 13.

The second cooker 11 is supplied with hydrogen gas from the supply system 3 via the pressure reducing valve 12, as illustrated in FIG. 3. The second cooker 11 is capable of heating and cooking by burning hydrogen gas. The second cooker 11 may be any cooker capable of heating and cooking by burning hydrogen gas. The second cooker 11 is, for example, a grill cooker. As illustrated in FIG. 1, the second cooker 11 is placed on the cooking table 13.

Hydrogen gas is supplied from the supply system 3 to the pressure reducing valve 12, as illustrated in FIG. 3. The pressure reducing valve 12 reduces the pressure of hydrogen gas supplied from the supply system 3 to a predetermined pressure. The predetermined pressure may be set according to the type of second cooker 11. For example, hydrogen gas at a pressure of approximately 0.2 [MPa] is supplied to the pressure reducing valve 12 from the supply system 3. In this case, when the second cooker 11 is a grill cooker, the pressure reducing valve 12 reduces the pressure of hydrogen gas to approximately 0.002 [MPa]. The pressure reducing valve 12 supplies hydrogen gas whose pressure has been reduced to the second cooker 11. The pressure reducing valve 12 may be incorporated into the cooking table 13, as illustrated in FIG. 1.

An end of the piping 4 illustrated in FIG. 2 is inserted into the cooking table 13. Hydrogen gas is supplied via the piping 4 to the pressure reducing valve 12 built into the cooking table 13.

The cooking table 13 is, for example, a rectangular, flat plate. The cooking table 13 includes four ends. Two opposing ends among these four ends are each provided with a leg 14.

The two legs 14 face each other. The two legs 14 each include two opposing ends. Of the two opposing ends included in the legs 14, the cooking table 13 is located at one end, and the plate 15 is located at the other end. Each leg 14 may be configured to include a rectangular, flat panel.

The plate 15 is, for example, a rectangular, flat plate. The planar size of the plate 15 may be approximately the same as the planar size of the cooking table 13. The plate 15 includes four corners. Each of these four corners is provided with a wheel 17.

The storage 16 is capable of housing the hydrogen module 20 and the fuel cell module 70, described below. The storage 16 may be identified as the area enclosed by the cooking table 13, the two legs 14, and the plate 15. When using the cooking system 2, the user can store the hydrogen module 20 and the fuel cell module 70 together in the storage 16.

Four wheels 17 are provided on the cooking table 13. In the present embodiment, the four wheels 17 are provided on the cooking table 13 via the legs 14 and the plate 15. In other words, in the present embodiment, the four wheels 17 are provided at the four respective corners of the plate 15. Each of the four wheels 17 is capable of rotating in the same direction. The provision of the wheels 17 enables the user to transport the cooking system 2 easily.

### Configuration of Supply System

The supply system 3 includes a hydrogen module 20 and a fuel cell module 70, as illustrated in FIG. 2. The hydrogen module 20 and the fuel cell module 70 are mechanically and electrically connected via a first connector 40 and a second connector 82, described below. The hydrogen module 20 and the fuel cell module 70 are connected via the piping 4, as illustrated in FIG. 2, so that hydrogen gas can circulate. FIG. 2 illustrates the supply system 3 as including two hydrogen modules 20 and one fuel cell module 70. The supply system 3 may, however, include any number of hydrogen modules 20 and any number of fuel cell modules 70. The hydrogen module 20 supplies hydrogen gas to the cooking system 2 and the fuel cell module 70, as illustrated in FIG. 3. The fuel cell module 70 generates electric power using hydrogen gas and the like supplied by the hydrogen module 20. The fuel cell module 70 supplies the generated electric power to the hydrogen module 20 and the cooking system 2.

### Configuration of Hydrogen Module

A hydrogen cartridge 21 is housed in the hydrogen module 20, as illustrated in FIG. 1. The hydrogen cartridge 21 is cylindrical. Hydrogen gas at a high pressure of approximately 70 [MPa] is stored in the hydrogen cartridge 21. The hydrogen cartridge 21 includes a handle 21A.

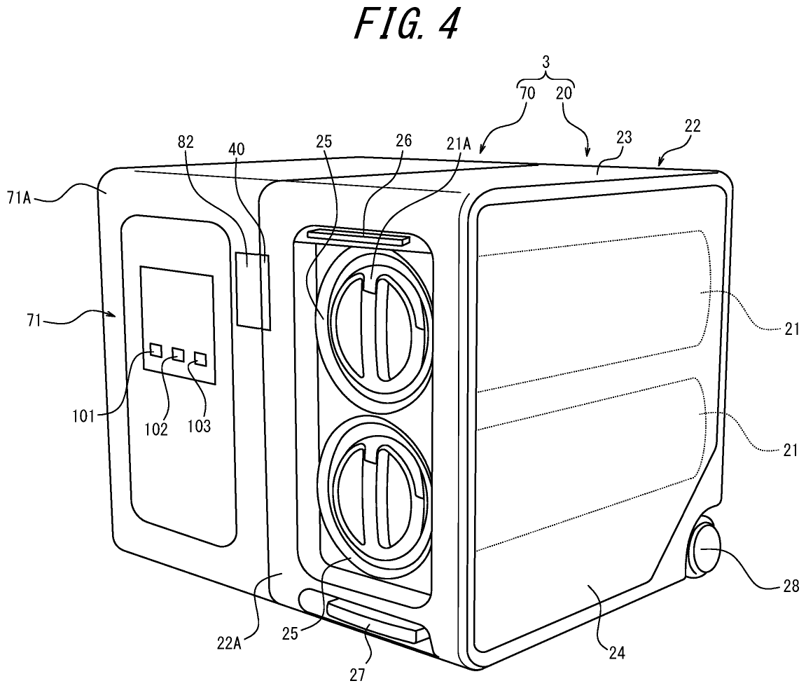

The hydrogen module 20 includes a first housing 22, as illustrated in FIG. 4. The first housing 22 according to the present embodiment is configured to house two hydrogen cartridges 21. It suffices, however, for the first housing 22 to be configured to house at least one hydrogen cartridge 21.

The first housing 22 is portable. In the present disclosure, “portable” means of a size that can be transported by the user. As an example, the size of the portable first housing 22 is 30 [cm] in width, 60 [cm] in height, and 60 [cm] in depth. By virtue of the first housing 22 having this size, the user can mount the hydrogen module 20 in the luggage compartment of a typical vehicle. The size of the portable first housing 22 is not, however, limited to this example and may be any size transportable by the user. As another example, the size of the portable first housing 22 may be 160 [cm] or less in width, 160 [cm] or less in height, and 160 [cm] or less in depth.

The first housing 22 is rectangular in shape. The rectangular first housing 22 includes six faces and eight corners. The first housing 22 includes a first side 22A and a second side 22B opposite the first side 22A. The first housing 22 may be made of any material, such as plastic or metal.

The first housing 22 includes a frame 23, two covers 24, two insertion openings 25, a shutter 26, a first handle 27, two wheels 28, and an extraction port 29. It suffices, however, for the first housing 22 to include at least one insertion opening 25 in a case in which the first housing 22 is configured to house at least one hydrogen cartridge 21. It also suffices for the first housing 22 to include at least one wheel 28.

The frame 23 is a square cylinder in shape. The square cylindrical frame 23 includes four sides and two openings. These four sides include the above-described first side 22A and second side 22B. The frame 23 may be made of any material, such as plastic.

Each cover 24 is transparent. Each cover 24 may be made of any material, such as transparent plastic or glass. The degree of transparency of each cover 24 may be set assuming that the hydrogen module 20 is irradiated by direct sunlight. The two covers 24 are attached to two respective openings in the frame 23. By virtue of the cover 24 being transparent, the user to easily confirm, through the cover 24, whether the hydrogen cartridge 21 is housed inside the first housing 22. Dust is also prevented from entering inside the first housing 22 by inclusion of the cover 24 in the first housing 22.

The two insertion openings 25 are located on the first side 22A. The hydrogen cartridge 21 can be inserted through the insertion opening 25. This means that the user can insert the hydrogen cartridge 21 into the first housing 22 through the insertion opening 25. After inserting the hydrogen cartridge 21 into the first housing 22, the user turns the hydrogen cartridge 21 by 90 degrees in a predetermined direction by twisting the handle 21A of the hydrogen cartridge 21. The hydrogen module 20 is configured so that the hydrogen cartridge 21 is secured inside the first housing 22 upon the hydrogen cartridge 21 being rotated by 90 degrees in the predetermined direction.

The shutter 26 is capable of switching the insertion opening 25 to an open state or a closed state. Before inserting the hydrogen cartridge 21 into the insertion opening 25, the user operates the shutter 26 to place the insertion opening 25 in the open state. After inserting the hydrogen cartridge 21 into the insertion opening 25, the user operates the shutter 26 to place the insertion opening 25 in the closed state. Dust is prevented from entering inside the first housing 22 through the insertion opening 25 by inclusion of the shutter 26 in the first housing 22.

The first handle 27 is capable of being inserted into and removed from the first housing 22. The first handle 27 may be provided so as to slide against the frame 23. The user removes the first handle 27 from the first housing 22 when transporting the hydrogen module 20. The user can easily transport the hydrogen module 20 by using the first handle 27. When storing the hydrogen module 20 in the storage 16 of the cooking system 2 as illustrated in FIG. 2, the user inserts the first handle 27 into the first housing 22. By the first handle 27 being inserted into the first housing 22, the hydrogen module 20 can be compactly stored in the storage 16.

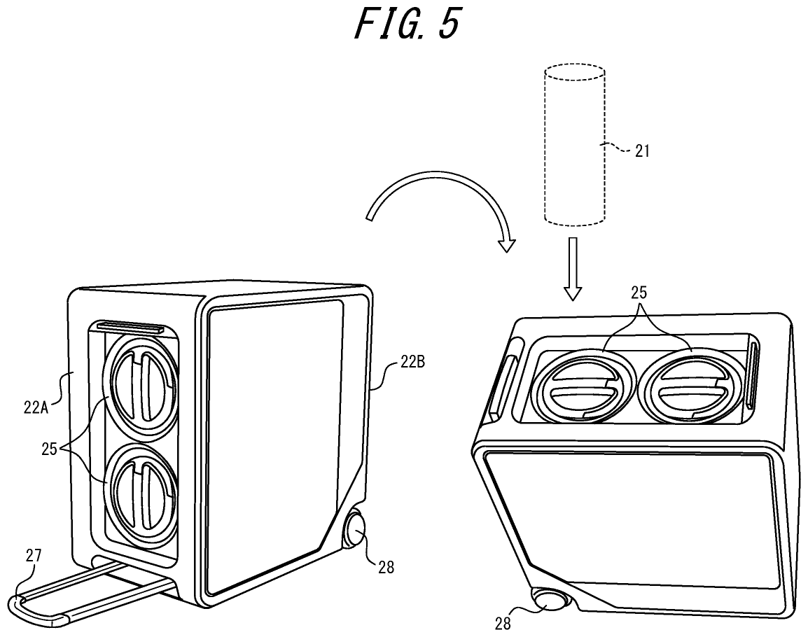

Each of the two wheels 28 are provided in the first housing 22 to be capable of rotating in the same direction. The two wheels 28 are each provided on respective edges of the second side 22B. In the present embodiment, the two wheels 28 are provided at two respective corners as edges of the second side 22B. Here, the first side 22A, on which the insertion openings 25 are located, is opposite the second side 22B, which has the wheels 28 provided on the edges thereof. The user can therefore use the wheels 28 as a fulcrum to rotate the first housing 22 to a position such that the insertion openings 25 face upwards, as illustrated in FIG. 5. By the insertion opening 25 facing upwards, the user can easily insert the hydrogen cartridge 21 inside the first housing 22 from above the insertion opening 25.

Hydrogen gas stored in the hydrogen module 20 is extracted from the extraction port 29. The extraction port 29 is provided on the second side 22B, as illustrated in FIG. 2. An end of the piping 4 is inserted into the extraction port 29. Hydrogen gas from the hydrogen module 20 is supplied to the fuel cell module 70 and the cooking system 2 via the piping 4. In FIG. 2, the piping 4 is inserted into the extraction port 29 of one of the two hydrogen modules 20 included in the supply system 3. However, the piping 4 may be inserted into the extraction ports 29 of all of the hydrogen modules 20 in the supply system 3.

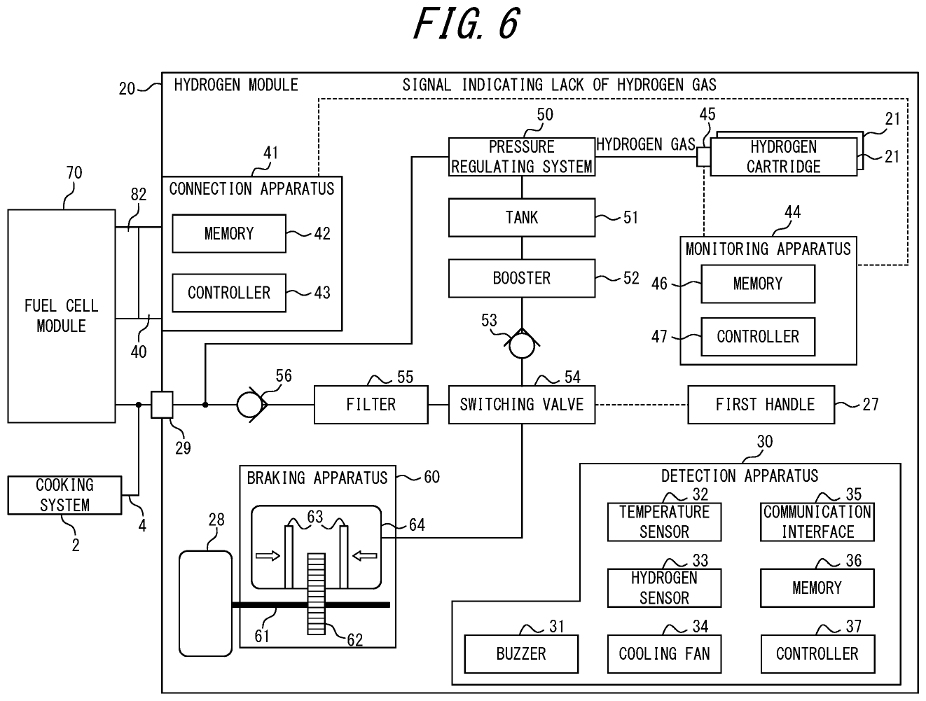

As illustrated in FIG. 6, the hydrogen module 20 includes a detection apparatus 30, a first connector 40, a connection apparatus 41, and a monitoring apparatus 44. The hydrogen module 20 includes a pressure regulating system 50, a tank 51, a booster 52, a check valve 53, a switching valve 54, a filter 55, a check valve 56, and a braking apparatus 60. In FIG. 6, the solid line indicates the flow of hydrogen gas. The dashed line indicates the flow of control.

The detection apparatus 30 is disposed inside the first housing 22. The detection apparatus 30 can detect hydrogen gas leaks inside the first housing 22 and detect temperature anomalies inside the first housing 22.

The detection apparatus 30 is supplied with electric power from the fuel cell module 70 via the connection apparatus 41, described below. Each component included in the detection apparatus 30, such as a buzzer 31 described below, operates on the electric power supplied by the fuel cell module 70. By each component of the detection apparatus 30 operating on the electric power supplied by the fuel cell module 70, the detection apparatus 30 does not need to be equipped with a battery. Since the detection apparatus 30 is not equipped with a battery, hydrogen gas that has leaked inside the first housing 22 can be prevented from igniting due to the heat of a battery. The hydrogen module 20 is therefore highly safe.

The detection apparatus 30 includes the buzzer 31, a temperature sensor 32, a hydrogen sensor 33, a cooling fan 34, a communication interface 35, a memory 36, and a controller 37.

The buzzer 31 is capable of emitting a buzzing sound. The buzzer 31 emits a buzzing sound based on control by the controller 37.

The temperature sensor 32 is capable of measuring the temperature inside the first housing 22. The temperature sensor 32 outputs the measured temperature inside the first housing 22 to the controller 37.

The hydrogen sensor 33 is capable of detecting hydrogen gas that has leaked inside the first housing 22. The hydrogen sensor 33 outputs a detection result to the controller 37 indicating whether hydrogen gas has leaked inside the first housing 22.

The cooling fan 34 is capable of cooling the interior of the first housing 22. The cooling fan 34 blows outside air into the first housing 22 in response to control by the controller 37. The cooling fan 34 cools the interior of the first housing 22 by blowing outside air into the first housing 22.

The communication interface 35 is capable of performing short-range wireless communication. The communication interface 35 is configured to include at least one communication module capable of performing short-range wireless communication. The communication module is a communication module compliant with a short-range wireless communication standard such as Bluetooth® (Bluetooth is a registered trademark in Japan, other countries, or both) or Wi-Fi® (Wi-Fi is a registered trademark in Japan, other countries, or both).

The memory 36 is configured to include at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM), dynamic random access memory (DRAM), or the like. The ROM is, for example, Electrically Erasable Programmable Read Only Memory (EEPROM) or the like. The memory 36 may function as a main memory, an auxiliary memory, or a cache memory. The memory 36 stores data to be used for operations of the detection apparatus 30 and data obtained by the operations of the detection apparatus 30.

The controller 37 is configured to include at least one processor, at least one dedicated circuit, or a combination thereof. Examples of the processor include a general purpose processor such as a CPU or a graphics processing unit (GPU) and a dedicated processor dedicated to specific processing. Examples of dedicated circuits can include a Field-Programmable Gate Array (FPGA) and an Application Specific Integrated Circuit (ASIC). The controller 37 executes processes related to the operations of the detection apparatus 30 while controlling the components of the detection apparatus 30.

The controller 37 acquires, from the temperature sensor 32, data on the temperature inside the first housing 22 as measured by the temperature sensor 32. In a case in which the acquired temperature inside the first housing 22 exceeds a temperature threshold, the controller 37 cools the interior of the first housing 22 with the cooling fan 34. The temperature threshold may be set based on regulations regarding the storage of hydrogen gas. The threshold is, for example, 40° C. The cooling of the interior of the first housing 22 in a case in which the temperature inside the first housing 22 exceeds the temperature threshold makes the hydrogen module 20 suitable for storing hydrogen cartridges 21 in which hydrogen gas is stored at high pressure.

The controller 37 acquires the hydrogen gas detection results from the hydrogen sensor 33. The controller 37 executes a notification process in a case in which hydrogen gas that has leaked inside the first housing 22 is detected by the hydrogen sensor 33. As an example of the notification process, the controller 37 causes the buzzer 31 to emit a buzzing sound. As another example of the notification process, the controller 37 transmits an alert indicating a hydrogen gas leak to the terminal apparatus of the user via the communication interface 35. As a result of the notification process being executed in a case in which hydrogen gas that has leaked inside the first housing 22 is detected, the hydrogen module 20 is made highly safe.

The first connector 40 is configured to connect to the second connector 82 of the fuel cell module 70. The hydrogen module 20 may be supplied with power from the fuel cell module 70 via the first connector 40 and the second connector 82.

The connection apparatus 41 controls the connection to the fuel cell module 70 via the first connector 40. The connection apparatus 41 includes a memory 42 and a controller 43.

The memory 42 may be configured to be identical or similar to the memory 36. The memory 42 stores data to be used for operations of the connection apparatus 41 and data obtained by the operations of the connection apparatus 41. For example, the memory 42 stores authentication information for the hydrogen module 20. The authentication information for the hydrogen module 20 may be any information that indicates that the hydrogen module 20 is authorized.

The controller 43 may be configured to be identical or similar to the controller 37.

Upon detecting that the first connector 40 has electrically connected to another connector, the controller 43 acquires the authentication information for the hydrogen module 20 from the memory 42. The controller 43 transmits the acquired authentication information for the hydrogen module 20 to the other connector electrically connected to the first connector 40. With this configuration, upon the first connector 40 being electrically connected to the second connector 82 of the fuel cell module 70 as the other connector, the authentication information for the hydrogen module 20 is transmitted from the hydrogen module 20 to the fuel cell module 70.

The controller 43 can acquire, from the monitoring apparatus 44, a signal indicating a lack of hydrogen gas, as described below. Upon acquiring the signal indicating a lack of hydrogen gas, the controller 43 transmits the signal indicating the lack of hydrogen gas to the fuel cell module 70 via the first connector 40.

The monitoring apparatus 44 monitors the remaining amount of hydrogen gas in the hydrogen cartridge 21. The monitoring apparatus 44 includes a pressure sensor 45, a memory 46, and a controller 47.

The pressure sensor 45 is disposed in any high-pressure piping between the hydrogen cartridge 21 and the pressure regulating system 50. High-pressure hydrogen gas stored in the hydrogen cartridge 21 circulates through the high-pressure piping. The pressure sensor 45 measures the pressure of hydrogen gas circulating through the high-pressure piping. The pressure sensor 45 outputs the measured hydrogen gas pressure to the controller 47.

The memory 46 may be configured to be identical or similar to the memory 36. The memory 46 stores data to be used for operations of the monitoring apparatus 44 and data obtained by the operations of the monitoring apparatus 44.

The controller 47 may be configured to be identical or similar to the controller 37.

The controller 47 acquires, from the pressure sensor 45, the measured pressure of the hydrogen gas circulating in the high-pressure piping. Based on the measured hydrogen gas pressure, the controller 47 monitors the remaining amount of hydrogen gas in the hydrogen cartridge 21 that supplies hydrogen gas to the pressure regulating system 50. In a case in which the remaining amount of hydrogen gas in the hydrogen cartridge 21 supplying hydrogen gas to the pressure regulating system 50 falls to or below a remaining amount threshold, the controller 47 determines whether another hydrogen cartridge 21 is filled with hydrogen gas. The remaining amount threshold may be set in consideration of factors such as the time required to control the switching of the hydrogen cartridge 21. In a case in which it is determined that another hydrogen cartridge 21 is filled with hydrogen gas, the controller 47 performs control so that the hydrogen cartridge 21 supplying hydrogen gas to the pressure regulating system 50 switches to the other hydrogen cartridge 21. Conversely, in a case in which it is determined that another hydrogen cartridge 21 is not filled with hydrogen gas, the controller 47 outputs a signal indicating a lack of hydrogen gas to the connection apparatus 41.

Hydrogen gas is supplied to the pressure regulating system 50 from the hydrogen cartridge 21. The pressure regulating system 50 reduces the pressure of the supplied hydrogen gas to a predetermined pressure. The predetermined pressure may be set according to the type of below-described fuel cell 80 provided in the fuel cell module 70. For example, in a case in which hydrogen gas at a high pressure of approximately 70 [MPa] is supplied from the hydrogen cartridge 21, the pressure regulating system 50 reduces the pressure of the hydrogen gas to approximately 0.2 [MPa]. The pressure regulating system 50 supplies hydrogen gas whose pressure has been reduced to the tank 51 and the extraction port 29.

The tank 51 is supplied with hydrogen gas from the pressure regulating system 50. The tank 51 temporarily holds the supplied hydrogen gas.

The booster 52 increases the pressure of the hydrogen gas held in the tank 51 to a predetermined pressure. The predetermined pressure may be set according to the specifications of the braking apparatus 60. The booster 52 supplies hydrogen gas whose pressure has been increased to the check valve 53.

The check valve 53 is connected between the booster 52 and the switching valve 54. The check valve 53 allows hydrogen gas to flow from the booster 52 to the switching valve 54. The check valve 53 prevents hydrogen gas from flowing from the switching valve 54 to the booster 52.

The switching valve 54 can switch the connection between the check valve 53, the filter 55, and the braking apparatus 60. The switching valve 54 is also capable of mechanically or electrically detecting whether the first handle 27 is removed from or inserted into the first housing 22.

Upon the first handle 27 being inserted into the first housing 22, the switching valve 54 switches to supply hydrogen gas from the hydrogen cartridge 21 to the braking apparatus 60. In the present embodiment, upon detecting that the first handle 27 has been inserted into the first housing 22, the switching valve 54 connects the check valve 53 with the braking apparatus 60 and disconnects the filter 55 from the check valve 53 and the braking apparatus 60. By thus connecting the check valve 53 with the braking apparatus 60, the switching valve 54 switches to supply hydrogen gas from the hydrogen cartridge 21 to the braking apparatus 60.

Upon the first handle 27 being removed from the first housing 22, the switching valve 54 switches to supply the hydrogen gas inside the braking apparatus 60 to other modules connected to the first housing 22. In the present embodiment, upon detecting that the first handle 27 has been removed from the first housing 22, the switching valve 54 connects the filter 55 with the braking apparatus 60 and disconnects the check valve 53 from the filter 55 and the braking apparatus 60. By thus connecting the filter 55 with the braking apparatus 60, the switching valve 54 switches to supply the hydrogen gas inside the braking apparatus 60 to the other modules via the filter 55 and the check valve 56. The other modules to which hydrogen gas from the braking apparatus 60 is supplied in the present embodiment are the fuel cell module 70 and the cooking system 2, which are connected to the first housing 22 via the extraction port 29 and the piping 4. However, these other modules may be any module connected to the first housing 22.

The filter 55 is supplied with hydrogen gas from the switching valve 54. The filter 55 removes foreign matter contained in the hydrogen gas. The filter 55 supplies the hydrogen gas from which the foreign matter has been removed to the check valve 56.

The check valve 56 is connected between the filter 55 and the extraction port 29. The check valve 56 allows hydrogen gas to flow from the filter 55 to the extraction port 29. The check valve 56 prevents hydrogen gas from flowing from the extraction port 29 to the filter 55.

The braking apparatus 60 applies a brake to the wheel 28. The braking apparatus 60 includes a rotating shaft 61 of the wheel 28, a rotor 62, two pads 63, and a cylinder 64.

The rotating shaft 61 is attached to the wheel 28. The rotor 62 is attached to the rotating shaft 61 of the wheels 28. The rotor 62 is located between the two pads 63. The two pads 63 are pressed against the rotor 62 by the pressure of hydrogen gas supplied to the braking apparatus 60. The two pads 63 and a part of the rotor 62 are disposed inside the cylinder 64.

The process flow during brake engagement and brake release is described below.

### During Brake Engagement

The user inserts the first handle 27 into the first housing 22 when not transporting the hydrogen module 20. As described above, upon the first handle 27 being inserted into the first housing 22, the switching valve 54 switches to supply hydrogen gas from the hydrogen cartridge 21 to the braking apparatus 60. Hydrogen gas from the hydrogen cartridge 21 is supplied to the braking apparatus 60, causing hydrogen gas to flow into the cylinder 64 of the braking apparatus 60. As hydrogen gas flows into the cylinder 64, the pressure inside the cylinder 64 increases. The increase in pressure inside the cylinder 64 causes the two pads 63 to press against the rotor 62. As a result of the two pads 63 being pressed against the rotor 62, a brake is applied to the wheel 28.

Upon the user thus inserting the first handle 27 into the first housing 22, the braking apparatus 60 applies a brake to the wheel 28. This configuration enables braking of the wheel 28 when the hydrogen module 20 is not being transported. Accordingly, the hydrogen module 20 is prevented from moving in an unintended direction when not being transported. As a result, the hydrogen module 20 is highly safe.

### During Brake Release

The user removes the first handle 27 from the first housing 22 before transporting the hydrogen module. As described above, upon the first handle 27 being removed from the first housing 22, the switching valve 54 switches to supply the hydrogen gas inside the braking apparatus 60 to other modules connected to the first housing 22. By the hydrogen gas inside the braking apparatus 60, i.e., inside the cylinder 64, being supplied to the other modules, the pressure inside the cylinder 64 is reduced. The reduction in pressure inside the cylinder 64 moves the two pads 63 away from the rotor 62. As a result of the two pads 63 moving away from the rotor 62, the brake applied to the wheel 28 is released.

Upon the first handle 27 thus being removed from the first housing 22, the brake applied to the wheel 28 is released. The hydrogen gas inside the braking apparatus 60 is supplied to the other modules, i.e., to the fuel cell module 70 and the cooking system 2 in the present embodiment. This configuration enables use of hydrogen gas without waste.

### Configuration of Fuel Cell Module

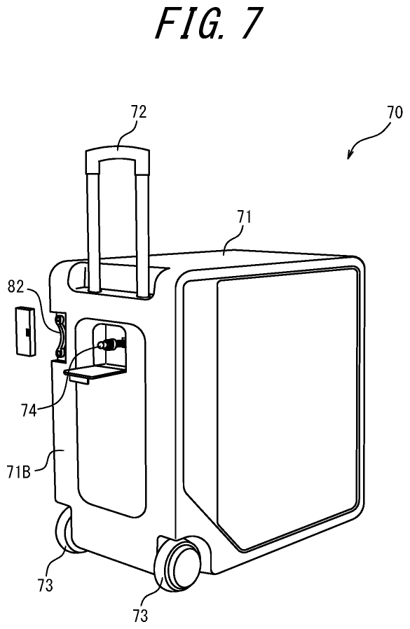

The fuel cell module 70 includes a second housing 71, as illustrated in FIG. 7. The second housing 71 is portable. The size of the second housing 71 may be identical to the size of the first housing 22. By the size of the second housing 71 and the size of the first housing 22 being identical, the fuel cell module 70 and the hydrogen module 20 can be made highly compatible in the hydrogen cooking system 1. This configuration enables the user to store any number of hydrogen modules 20 and any number of fuel cell modules 70 in the storage 16.

The second housing 71 is rectangular in shape. The rectangular second housing 71 includes six faces and eight corners. The second housing 71 includes a first side 71A and a second side 71B opposite the first side 71A, as illustrated in FIG. 4 and FIG. 7. The second housing 71 may be made of any material, such as plastic or metal.

The second housing 71 includes a second handle 72, two wheels 73, and an intake port 74, as illustrated in FIG. 7. It suffices, however, for the second housing 71 to include at least one wheel 73.

The second handle 72 is capable of being inserted into and removed from the second housing 71. The second handle 72 may be provided so as to slide against the second housing 71. The second handle 72 is provided at an end of the second side 71B. The user removes the second handle 72 from the second housing 71, as illustrated in FIG. 7, when transporting the fuel cell module 70. The user can easily transport the fuel cell module 70 by using the second handle 72. When storing the fuel cell module 70 in the storage 16 of the cooking system 2 as illustrated in FIG. 1, the user inserts the second handle 72 into the second housing 71. By the second handle 72 being inserted into the second housing 71, the fuel cell module 70 can be compactly stored in the storage 16.

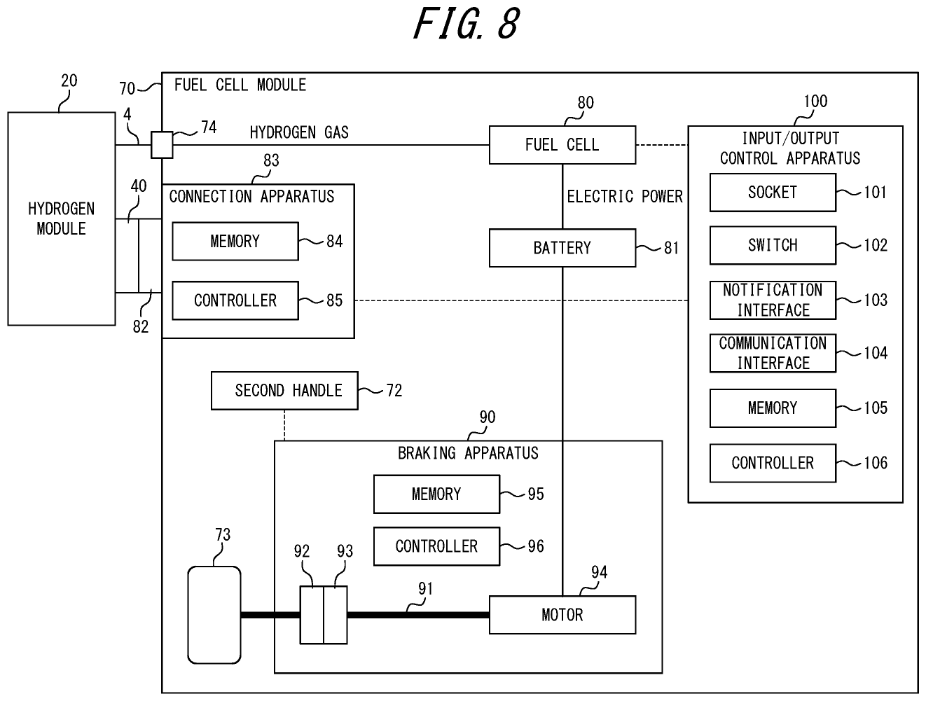

Upon being removed from the second housing 71, the second handle 72 outputs an electrical signal to a below-described drive apparatus 90, illustrated in FIG. 8, indicating that the second handle 72 has been removed from the second housing 71. Upon being inserted into the second housing 71, the second handle 72 outputs an electrical signal to the below-described drive apparatus 90, illustrated in FIG. 8, indicating that the second handle 72 has been inserted into the second housing 71.

The two wheels 73 are provided in the second housing 71 to be capable of rotating in the same direction. Among the ends of the second side 71B, the two wheels 73 are provided at the end opposite the end at which the second handle 72 is provided. The two wheels 73 are provided at two respective corners of the second side 71B.

Hydrogen gas is drawn into the fuel cell module 70 through the intake port 74. The intake port 74 is provided on the second side 71B, as illustrated in FIG. 7. As illustrated in FIG. 2, an end of the piping 4 is inserted into the intake port 74.

As illustrated in FIG. 8, the fuel cell module 70 includes the fuel cell 80, a battery 81, the second connector 82, a connection apparatus 83, the drive apparatus 90, and an input/output control apparatus 100. In FIG. 8, the solid line indicates the flow of hydrogen gas or electric power. The dashed line indicates the flow of control.

Hydrogen gas is supplied to the fuel cell 80 from the hydrogen module 20 via the intake port 74. The fuel cell 80 generates electric power through an electrochemical reaction using hydrogen gas and oxygen. The fuel cell 80 supplies the generated electric power to the battery 81.

The fuel cell 80 may be any fuel cell, such as a Polymer Electrolyte Fuel Cell (PEFC). In the case of being a PEFC, the fuel cell 80 can start generating electric power relatively sooner after startup than in the case of being a Solid Oxide Fuel Cell (SOFC), for example. The rated power generated by the fuel cell 80 is, for example, approximately 3000 [W].

The battery 81 is, for example, a secondary battery. The battery 81 may be any battery, such as a lithium ion battery.

The battery 81 is charged by the electric power generated by the fuel cell 80. The electricity charged in the battery 81 is supplied to the drive apparatus 90. The electricity charged in the battery 81 may be supplied to the hydrogen module 20 and the cooking system 2. Alternatively, the electric power generated by the fuel cell 80 may be supplied directly to the hydrogen module 20 and the cooking system 2.

The second connector 82 is configured to connect to the first connector 40 of the hydrogen module 20. The electricity charged in the battery 81 or the electric power generated by the fuel cell 80 may be supplied to the hydrogen module 20 via the second connector 82 and the first connector 40.

The connection apparatus 83 controls the connection to the hydrogen module 20 via the second connector 82. The connection apparatus 83 includes a memory 84 and a controller 85.

The memory 84 may be configured to be identical or similar to the memory 36 of the detection apparatus 30 illustrated in FIG. 6. The memory 84 stores data to be used for operations of the connection apparatus 83 and data obtained by the operations of the connection apparatus 83. For example, the memory 84 stores authentication information for authorized hydrogen modules 20.

The controller 85 may be configured to be identical or similar to the controller 37 of the detection apparatus 30 illustrated in FIG. 6.

Upon connection of another module to the second connector 82, the controller 85 executes an authentication process to authenticate the other module. As an example of the authentication process, the controller 85 receives, via the second connector 82, authentication information for the other module connected to the second connector 82. For example, the other module is assumed to be the hydrogen module 20. In this case, upon the first connector 40 of the hydrogen module 20 being electrically connected to the second connector 82, the authentication information for the hydrogen module 20 is transmitted from the hydrogen module 20 to the fuel cell module 70, as described above. The controller 85 receives the authentication information for the hydrogen module 20 via the second connector 82 as the authentication information for the other module in this case. Upon receiving the authentication information for the other module connected to the second connector 82, the controller 85 authenticates the other module based on the authentication information for authorized hydrogen modules 20 stored in the memory 84. As an example, the controller 85 determines that the authentication of the other module is successful in a case in which the received authentication information for the other module matches the authentication information for authorized hydrogen modules 20 stored in the memory 84. Conversely, the controller 85 determines that the authentication of the other module fails in a case in which the received authentication information for the other module does not match the authentication information for authorized hydrogen modules 20 stored in the memory 84.

In this way, the authentication of the other module succeeds in a case in which the other module is an authorized hydrogen module. The authentication of the other module fails in a case in which the other module is an unauthorized hydrogen module.

In a case in which authentication of the other module is successful, the controller 85 receives the supply of hydrogen gas to the fuel cell module 70 from the other module, i.e., the hydrogen module 20. Conversely, in a case in which authentication of the other module fails, the controller 85 does not receive the supply of hydrogen gas to the fuel cell module 70 from the other module. This configuration can prevent the fuel cell module 70 from receiving a hydrogen gas supply from an unauthorized hydrogen module in a case in which such an unauthorized hydrogen module is connected to the fuel cell module 70. As a result of the fuel cell module 70 being prevented from receiving a hydrogen gas supply from an unauthorized hydrogen module, the supply system 3 is made highly safe.

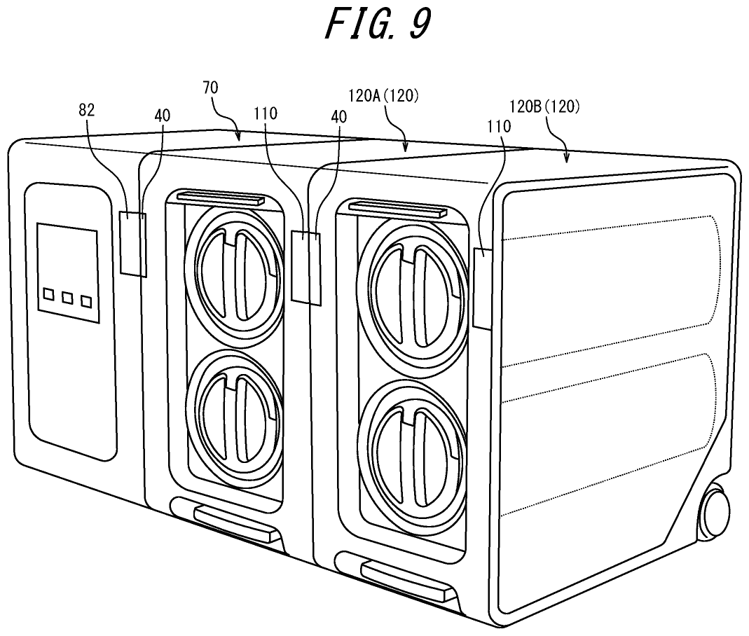

The controller 85 can receive a signal, from the hydrogen module 20 via the second connector 82, indicating a lack of hydrogen gas. In a case of receiving the signal indicating a lack of hydrogen gas, the controller 85 determines whether another hydrogen module 20 is connected to the fuel cell module 70 via the piping 4, as described below with reference to FIG. 9. In a case in which it is determined that another hydrogen module 20 is connected to the fuel cell module 70, and the other hydrogen module 20 is filled with hydrogen gas, the controller 85 performs control to receive a supply of hydrogen gas from the other hydrogen module 20. Conversely, in a case in which it is determined that another hydrogen module 20 is not connected to the fuel cell module 70, the controller 85 outputs a signal indicating a lack of hydrogen gas to the input/output control apparatus 100.

The drive apparatus 90 can drive the wheel 73. The drive apparatus 90 includes a rotating shaft 91 of the wheel 73, a one-way clutch 92, a sensor 93, a motor 94, a memory 95, and a controller 96.

The rotating shaft 91 is attached to the wheel 73. In FIG. 8, the rotating shaft 91 is attached to one wheel 73. However, in a case in which the second housing 71 includes two wheels 73, the rotating shaft 91 may be attached to the two wheels 73.

The one-way clutch 92 is attached to the rotating shaft 91 of the wheel 73. When a rotational force in the positive direction is applied to the rotating shaft 91, the one-way clutch 92 transmits the rotational force to the wheel 73. When a rotational force in the opposite direction than the positive rotational force is applied to the rotating shaft of the wheel 73, the one-way clutch 92 does not transmit the rotational force to the wheel 73. The positive direction is the direction in which the user transports the fuel cell module 70 using the second handle 72. The positive direction may be set according to the form of use of the fuel cell module 70.

The sensor 93 is capable of measuring the pulling force that pulls the second housing 71. For example, when the user is transporting the fuel cell module 70, the second housing 71 experiences a pulling force.

The sensor 93 is, for example, configured to include a torque sensor. The sensor 93 is attached to the rotating shaft 91 of the wheel 73. The sensor 93 measures the amount of rotation of the wheel 73. The sensor 93 measures the pulling force that pulls the second housing 71 based on the measured amount of rotation of the wheel 73. The sensor 93 outputs the measured pulling force to the controller 96.

The motor 94 is capable of rotating the wheel 73. The motor 94 is capable of being driven by the electric power generated by the fuel cell 80. In the present embodiment, the motor 94 is attached to the rotating shaft 91 of the wheel 73. Electricity from the battery 81 is supplied to the motor 94. The motor 94 rotates the wheel 73 via the rotating shaft 91 based on control by the controller 96.

The memory 95 may be configured to be identical or similar to the memory 36 of the detection apparatus 30 illustrated in FIG. 6. The memory 95 stores data to be used for operations of the drive apparatus 90 and data obtained by the operations of the drive apparatus 90.

The controller 96 may be configured to be identical or similar to the controller 37 of the detection apparatus 30 illustrated in FIG. 6.

Upon the second handle 72 being removed from the second housing 71, the controller 96 acquires, from the sensor 93, the pulling force measured by the sensor 93. In the present embodiment, the controller 96 acquires the measured pulling force from the sensor 93 upon acquiring, from the second handle 72, an electrical signal indicating that the second handle 72 has been removed from the second housing 71. The controller 96 determines the rotation speed of the motor 94 based on the acquired measurement of the pulling force. The controller 96 may determine the rotation speed of the motor 94 so that the ratio of an assist force to the pulling force is a predetermined ratio. The assist force is the force that moves the second housing 71 in the positive direction by rotation of the motor 94. The predetermined ratio may be set according to the weight of the fuel cell module 70, the form of use, or the like. Upon determining the rotation speed of the motor 94, the controller 96 rotates the motor 94 at the determined rotation speed.

The controller 96 thus rotates the motor 94 at the determined rotation speed upon the second handle 72 being removed from the second housing 71. As described above, the user removes the second handle 72 from the second housing 71 when transporting the second housing 71. This means that when the user transports the second housing 71, the motor 94 can be rotated. This configuration enables the user to transport the fuel cell module 70 easily.

The controller 96 stops the motor 94 upon the second handle 72 being inserted into the second housing 71. In the present embodiment, the controller 96 stops the motor 94 upon acquiring, from the second handle 72, an electrical signal indicating that the second handle 72 has been inserted into the second housing 71.

The controller 96 thus stops the motor 94 when the second handle 72 is inserted into the second housing 71. As described above, the user inserts the second handle 72 into the second housing 71 when not transporting the fuel cell module 70 or when generating electric power with the fuel cell module 70. In other words, the motor 94 can be stopped when the fuel cell module 70 is not being transported or when the fuel cell module 70 is being used to generate electric power. This configuration can prevent the sensor 93 from measuring an unintended force, applied to the second housing 71, as a pulling force and driving the motor 94 when, for example, the fuel cell module 70 is generating electric power.

The input/output control apparatus 100 includes a socket 101, a switch 102, a notification interface 103, a communication interface 104, a memory 105, and a controller 106.

A Universal Serial Bus (USB) terminal can be plugged into the socket 101. The socket 101 may be a USB port. The socket 101 may be any USB type A port, USB type B port, or USB type C port. The socket 101 may be disposed on the first side 71A of the second housing 71, as illustrated in FIG. 4.

The switch 102 is a switch that starts or stops the fuel cell 80. The switch 102 may be disposed on the first side 71A of the second housing 71, as illustrated in FIG. 4. The user operates the switch 102 when wishing to start or stop the fuel cell 80.

The notification interface 103 notifies the user of information. The notification interface 103 is, for example, a lamp. In a case in which the notification interface 103 is a lamp, notification is provided by illumination of the lamp. The notification interface 103 may be disposed on the first side 71A of the second housing 71, as illustrated in FIG. 4.

The communication interface 104 is capable of performing short-range wireless communication. The communication interface 104 is configured to include at least one communication module capable of performing short-range wireless communication. The communication module is a communication module compliant with a short-range wireless communication standard such as Bluetooth® or Wi-Fi®.

The memory 105 may be configured to be identical or similar to the memory 36 of the detection apparatus 30 illustrated in FIG. 6. The memory 105 stores data to be used for the operations of the input/output control apparatus 100 and data obtained by the operations of the input/output control apparatus 100.

The controller 106 may be configured to be identical or similar to the controller 37 of the detection apparatus 30 illustrated in FIG. 6.

The controller 106 performs control so that when a USB terminal is plugged into the socket 101, electricity from the battery 18 is supplied to the USB terminal plugged into the socket 101. This configuration enables the user to charge any electronic device by plugging a USB terminal of the electronic device into the socket 101.

Upon detecting user operation on the switch 102, the controller 106 executes a process in response to the detected user operation. For example, in a case in which the user operation on the switch 102 is to start the fuel cell 80, the controller 106 outputs a signal to the fuel cell 80 to start the fuel cell 80. In a case in which the user operation on the switch 102 is to stop the fuel cell 80, the controller 106 outputs a signal to the fuel cell 80 to stop the fuel cell 80.

In a case in which the fuel cell 80 is started, the controller 106 controls the notification interface 103 to provide notification of whether the fuel cell 80 has properly started. For example, in a case in which the notification interface 103 is a lamp, the controller 106 controls the notification interface 103 to emit blue light when the fuel cell 80 has properly started. Furthermore, in a case in which the notification interface 103 is a lamp, the controller 106 controls the notification interface 103 to emit red light when the fuel cell 80 has not properly started. This configuration enables the user to confirm whether the fuel cell 80 has properly started after the user operates the switch 102.

The controller 106 transmits information about the operation of the fuel cell 80 to the terminal apparatus of the user via the communication interface 104. The information about the operation of the fuel cell 80 may, for example, include any information such as the electrical energy generated by the fuel cell 80 or the remaining amount of hydrogen gas stored in the hydrogen module 20. This configuration enables the user to learn the operational status and the like of the fuel cell 80.

The controller 106 may accept various settings for the fuel cell 80 by receiving various settings for the fuel cell 80 from the terminal apparatus of the user via the communication interface 104. The controller 106 may execute processes according to the various settings accepted for the fuel cell 80.

The controller 106 can acquire, from the connection apparatus 83, a signal indicating a lack of hydrogen gas. In a case in which the controller 106 receives a signal indicating a lack of hydrogen gas, the controller 106 transmits a notification indicating the lack of hydrogen gas to the terminal apparatus of the user via the communication interface 104. By the notification indicating the lack of hydrogen gas being transmitted to the terminal apparatus of the user, the terminal apparatus of the user can display the notification indicating the lack of hydrogen gas. This configuration enables the user to know that the hydrogen module 20 is out of hydrogen gas.

The supply system 3 according to the present embodiment thus includes the hydrogen module 20 and the fuel cell module 70. The hydrogen module 20 includes the portable first housing 22 that has at least one wheel 28, as illustrated in FIG. 4. This first housing 22 enables the user to transport the hydrogen module 20 easily. The fuel cell module 70 also includes the second first housing 71 that has at least one wheel 73, as illustrated in FIG. 7. This second housing 71 enables the user to transport the fuel cell module 70 easily. According to the present embodiment, the portability of the supply system 3 can therefore be improved.

Furthermore, in the present embodiment, the first housing 22 may further include the transparent cover 24, as illustrated in FIG. 4. This configuration enables the user to easily confirm, through the cover 24, whether the hydrogen cartridge 21 is housed inside the first housing 22, as described above. As also described above, dust is prevented from entering inside the first housing 22 by inclusion of the cover 24 in the first housing 22.

In the present embodiment, the first housing 22 may further include the insertion opening 25 and the shutter 26 that is capable of switching the insertion opening 25 between an open state and a closed state, as illustrated in FIG. 4. Dust is prevented from entering inside the first housing 22 through the insertion opening 25 by inclusion of the shutter 26 in the first housing 22, as described above.

In the first housing 22 according to the present embodiment, the wheels 28 may be provided on the edge of the second side 22B. According to this configuration, the user can use the wheels 28 as a fulcrum to rotate the first housing 22 to a position such that the insertion openings 25 face upwards, as described above with reference to FIG. 5. By the insertion opening 25 facing upwards, the user can easily insert the hydrogen cartridge 21 inside the first housing 22 from above the insertion opening 25.

In the present embodiment, the hydrogen module 20 may further include the cooling fan 34, the temperature sensor 32, and the controller 37, as illustrated in FIG. 6. In a case in which the temperature inside the first housing 22, as measured by the temperature sensor 32, exceeds a temperature threshold, the controller 37 may cool the interior of the first housing 22 with the cooling fan 34. This configuration makes the hydrogen module 20 suitable for storing hydrogen cartridges 21 in which hydrogen gas is stored at high pressure, as described above.

In the present embodiment, the hydrogen module 20 may further include the hydrogen sensor 33 and the controller 37, as illustrated in FIG. 6. The controller 37 may execute a notification process in a case in which hydrogen gas that has leaked inside the first housing 22 is detected by the hydrogen sensor 33. This configuration makes the hydrogen module 20 highly safe, as described above.

In the present embodiment, the buzzer 31, the temperature sensor 32, the hydrogen sensor 33, the cooling fan 34, the communication interface 35, the memory 36, and the controller 37, illustrated in FIG. 6, may operate on electric power supplied from the fuel cell module 70. This configuration makes the hydrogen module 20 highly safe, as described above.

In the present embodiment, the first housing 22 may further include the first handle 27 that can be inserted into and removed from the first housing 22, as illustrated in FIG. 4. As described above, the user can easily transport the hydrogen module 20 by using the first handle 27. As also described above, when storing the hydrogen module 20 in the storage 16 of the cooking system 2 as illustrated in FIG. 2, the user can insert the first handle 27 into the first housing 22. By the first handle 27 being inserted into the first housing 22, the hydrogen module 20 can be compactly stored in the storage 16.

In the present embodiment, the hydrogen module 20 may further include the braking apparatus 60 and the switching valve 54, as illustrated in FIG. 6. Upon the first handle 27 being inserted into the first housing 22, the switching valve 54 may supply hydrogen gas from the hydrogen cartridge 21 to the braking apparatus 60. As described above, this configuration enables braking of the wheel 28 when the hydrogen module 20 is not being transported. Therefore, as described above, the hydrogen module 20 is highly safe.

In the present embodiment, upon the first handle 27 being removed from the first housing 22, the switching valve 54 may supply the hydrogen gas inside the braking apparatus 60 to other modules connected to the first housing 22. This configuration enables use of hydrogen gas without waste, as described above.

In the present embodiment, the fuel cell module 70 may further include the second connector 82 and the controller 85, as illustrated in FIG. 8. Upon connection of another module to the second connector 82, the controller 85 may execute an authentication process to authenticate the other module. In a case in which authentication of the other module is successful, the controller 85 may receive the supply of hydrogen gas to the fuel cell module 70 from the other module, i.e., the hydrogen module 20. This configuration makes the supply system 3 highly safe, as described above.

In the present embodiment, the second housing 71 may further include the second handle 72 that can be inserted into and removed from the second housing 71, as illustrated in FIG. 7. As described above, the user can easily transport the fuel cell module 70 by using the second handle 72. As also described above, when storing the fuel cell module 70 in the storage 16 of the cooking system 2 as illustrated in FIG. 2, the user can insert the second handle 72 into the second housing 71. By the second handle 72 being inserted into the second housing 71, the fuel cell module 70 can be compactly stored in the storage 16.

In the present embodiment, the fuel cell module 70 may further include the motor 94, the sensor 93, and the controller 96, as illustrated in FIG. 8. Upon the second handle 72 being removed from the second housing 71, the controller 96 may determine the rotation speed based on the pulling force measured by the sensor 93. The controller 96 may rotate the motor 94 at the determined rotation speed. This configuration enables the user to transport the fuel cell module 70 easily, as described above. The controller 96 may also stop the motor 94 when the second handle 72 is inserted into the second housing 71. As described above, this configuration can prevent the sensor 93 from measuring an unintended force, applied to the second housing 71, as a pulling force and driving the motor 94 when, for example, the fuel cell module 70 is generating electric power.

In the present embodiment, the fuel cell module 70 may further include the switch 102 that starts the fuel cell 80, the notification interface 103, and the controller 106, as illustrated in FIG. 8. The controller 106 may control the notification interface 103 to provide notification of whether the fuel cell 80 has properly started. As described above, this configuration enables the user to confirm whether the fuel cell 80 has properly started after the user operates the switch 102.

In the present embodiment, the fuel cell module 70 may further include the communication interface 104 capable of performing short-range wireless communication and the controller 106. The controller 106 may transmit information about the operation of the fuel cell 80 to the terminal apparatus of the user via the communication interface 104. As described above, this configuration enables the user to learn the operational status and the like of the fuel cell 80.

In the present embodiment, the size of the first housing 22 and the size of the second housing 71 may be identical. As a result of the size of the first housing 22 and the size of the second housing 71 being identical, the user can store any number of hydrogen modules 20 and any number of fuel cell modules 70 in the storage 16, as described above.

In the present embodiment, the cooking system 2 may include the first cooker 10, the second cooker 11, and the pressure reducing valve 12, as illustrated in FIG. 3. The pressure reducing valve 12 may reduce the pressure of hydrogen gas supplied from the supply system 3 to a predetermined pressure. The second cooker 11 may be supplied with hydrogen gas whose pressure has been reduced by the pressure reducing valve 12. Here, in general, the pressure of hydrogen gas that is usable in the second cooker 11 is often lower than the pressure of hydrogen gas that is usable in the fuel cell module 70. Even in a case in which the pressure of hydrogen gas usable in the second cooker 11 is low, the second cooker 11 can still be used by using hydrogen gas supplied to the cooking system 2 from the supply system 3, by virtue of the cooking system 2 including the pressure reducing valve 12.

In the present embodiment, the cooking system 2 may further include the storage 16 that is capable of housing the hydrogen module 20 and the fuel cell module, as illustrated in FIG. 1. According to this configuration, when using the cooking system 2, the user can store the hydrogen module 20 and the fuel cell module 70 together in the storage 16, as described above.

In the present embodiment, the cooking system 2 may further include the cooking table 13 and at least one wheel 17, as illustrated in FIG. 1 and FIG. 2. The inclusion of the wheel 17 in the cooking system 2 enables the user to transport the cooking system 2 easily.

In the present embodiment, the hydrogen module 20 may include a plurality of hydrogen cartridges 21. In a case in which the remaining amount of hydrogen gas in the hydrogen cartridge 21 that is supplying hydrogen gas to the fuel cell module 70 falls to or below a remaining amount threshold, the hydrogen module 20 may switch the hydrogen cartridge 21 that is supplying hydrogen gas to the fuel cell module 70 to another hydrogen cartridge 21. The other hydrogen cartridge 21 may be a hydrogen cartridge filled with hydrogen gas. As an example of this process, the hydrogen module 20 may include the monitoring apparatus 44, as described above with reference to FIG. 6. As described above, in a case in which the remaining amount of hydrogen gas in the hydrogen cartridge 21 supplying hydrogen gas to the pressure regulating system 50 falls to or below a remaining amount threshold, the controller 47 of the monitoring apparatus 44 may determine whether another hydrogen cartridge 21 is filled with hydrogen gas. In a case in which it is determined that another hydrogen cartridge 21 is filled with hydrogen gas, the controller 47 may perform control so that the hydrogen cartridge 21 supplying hydrogen gas to the pressure regulating system 50 switches to the other hydrogen cartridge 21. According to this configuration, in a case in which the remaining amount of hydrogen gas in the hydrogen cartridge 21 that is supplying hydrogen gas to the fuel cell module 70 falls to or below a remaining amount threshold, the hydrogen cartridge 21 that is supplying hydrogen gas to the fuel cell module 70 is switched to another hydrogen cartridge 21. This switch to another hydrogen cartridge 21 enables the user to continue using the cooking system 2.

In the present embodiment, the supply system 3 may include a plurality of hydrogen modules 20. In this case, when a remaining amount of hydrogen gas in every one of the at least one hydrogen cartridge 21 included in the hydrogen module 20 that is supplying hydrogen gas to the fuel cell module 70 falls to or below a remaining amount threshold, the hydrogen module 20 may transmit a signal indicating a lack of hydrogen gas to the fuel cell module 70. In a case in which the fuel cell module 70 receives the signal indicating the lack of hydrogen gas, and another hydrogen module 20 other than the hydrogen module 20 that transmitted the signal is filled with hydrogen gas, the fuel cell module 70 may perform control to receive a supply of hydrogen gas from the other hydrogen module. This switch to another hydrogen module 20 enables the user to continue using the cooking system 2.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

In the above embodiment, the storage 16 illustrated in FIG. 1 has been described as housing the hydrogen module 20 and the fuel cell module 70. However, other modules besides the hydrogen module 20 and fuel cell module 70 may be housed in the storage 16. The housing for the other modules may be of the same size as the first housing 22 and the second housing 71. For example, a refrigerator may be another module housed in the storage 16.

In the above embodiment, the hydrogen module 20 and the fuel cell module 70 have been described as connected via the first connector 40 and the second connector 82, as illustrated in FIG. 4. A plurality of hydrogen modules 20 may, however, be connected via connectors. This example is explained below with reference to FIG. 9.

FIG. 9 illustrates the external configuration of hydrogen modules 120A, 120B according to a variation of the present disclosure. When not specifically distinguishing therebetween, the hydrogen modules 120A and 120B are also referred to simply as the “hydrogen module 120”. The hydrogen module 120 further includes a third connector 110. In FIG. 9, the piping 4 illustrated in FIG. 2 may include four or more ends.

The third connector 110 of the hydrogen module 120 is configured to connect to the first connector 40 of another hydrogen module 120. In FIG. 9, the third connector 110 of the hydrogen module 120A is connected to the first connector 40 of another hydrogen module 120B. The first connector 40 of the hydrogen module 120A is connected to the second connector 82 of the fuel cell module 70.

The connection apparatus 41, as illustrated in FIG. 6, of one hydrogen module 120 mediates communication between another hydrogen module 120 connected to the one hydrogen module 120 via the third connector 110 and the fuel cell module 70 connected to the one hydrogen module 120 via the first connector 40. The connection apparatus 41 of one hydrogen module 120 may perform control so that electric power from the fuel cell module 70 connected to the one hydrogen module 120 is supplied to another hydrogen module 120 connected to the one hydrogen module 120. In FIG. 9, the controller 43 of the connection apparatus 41 of the hydrogen module 120A mediates communication between the fuel cell module 70 and the hydrogen module 120B. The controller 43 of the connection apparatus 41 of the hydrogen module 120A also performs control so that electric power from the fuel cell module 70 is supplied to the hydrogen module 120B.

The connection apparatus 41 of the hydrogen module 120 may include a communication interface that is the same as or similar to the communication interface 35 illustrated in FIG. 6.

Ends of the piping 4 are inserted into the extraction port 29, illustrated in FIG. 2, of each of the hydrogen modules 120A, 120B. With this configuration, the hydrogen modules 120A, 120B are connected to the fuel cell module 70 and the cooking system 2 via the piping 4. Once the hydrogen modules 120A, 120B, the fuel cell module 70, and the like are connected via the piping 4, the user may operate the terminal apparatus to transmit a predetermined signal from the terminal apparatus to the hydrogen modules 120A, 120B. The predetermined signal may be a signal indicating that the hydrogen module 120 and the fuel cell module 70 are connected. By receiving this predetermined signal via the communication interface, the controller 43 of the connection apparatus 41 in the hydrogen module 120 can detect that the hydrogen module 120 and the fuel cell module 70 are connected via the piping 4. In response to an instruction from the fuel cell module 70, the controller 43 of one hydrogen module 120 may transmit a signal to the fuel cell module 70, via another hydrogen module 120, indicating that the one hydrogen module 120 and the fuel cell module 70 are connected via the piping 4. Also, in response to an instruction from the fuel cell module 70, the controller 43 of one hydrogen module 120 may transmit a signal to the fuel cell module 70, via another hydrogen module 120, indicating that the one hydrogen module 120 is filled with hydrogen gas.

As a result of a plurality of hydrogen modules 120 being connected in this way, the fuel cell module 70 can communicate with another hydrogen module 120 via the hydrogen module 120 connected to the fuel cell module. This configuration enables execution of the following process, for example.

Assume that the controller 85 of the fuel cell module 70 receives a signal, from the hydrogen module 120A via the second connector 82, indicating a lack of hydrogen gas. In this case, the controller 85 communicates with the hydrogen module 120B via the hydrogen module 120A to determine whether the other hydrogen module 120B is connected to the fuel cell module 70 via the piping 4. For example, assume that the controller 85 receives a signal, from the hydrogen module 120B via the hydrogen module 120A, indicating that the hydrogen module 120B and the fuel cell module 70 are connected via the piping 4. In this case, the controller 85 determines that the hydrogen module 120B is connected to the fuel cell module 70 via the piping 4. In a case in which it is determined that the other hydrogen module 120B is connected to the fuel cell module 70 via the piping 4, and that the other hydrogen module 120B is filled with hydrogen gas, the controller 85 performs control to receive a supply of hydrogen gas from the hydrogen module 120B. For example, assume that the controller 85 receives a signal, from the hydrogen module 120B via the hydrogen module 120A, indicating that the hydrogen module 120B is filled with hydrogen gas. In this case, the controller 85 determines that the hydrogen module 120B is filled with hydrogen gas and transmits a signal, to the hydrogen module 120B via the hydrogen module 120A, instructing the hydrogen module 120B to supply hydrogen gas. This configuration enables a supply of hydrogen gas from the hydrogen module 120B to the fuel cell module 70 and the cooking system 2 via the piping 4 even in a case in which the hydrogen module 120A lacks hydrogen gas.

Examples of some embodiments of the present disclosure are described below. However, it should be noted that the embodiments of the present disclosure are not limited to these.

[Appendix 1] A supply system comprising:
at least one hydrogen module comprising a portable first housing and at least one hydrogen cartridge housed in the first housing, the first housing including at least one wheel; and
a fuel cell module comprising a portable second housing and a fuel cell housed in the second housing, the second housing including at least one wheel, wherein
the fuel cell module and the hydrogen module are mechanically and electrically connected, and
the fuel cell is capable of generating electric power from hydrogen gas supplied by the hydrogen module.
   [Appendix 2] The supply system according to appendix 1, wherein the first housing further includes a transparent cover.
   [Appendix 3] The supply system according to appendix 1 or 2, wherein the first housing further includes an insertion opening into which the hydrogen cartridge can be inserted and a shutter capable of switching the insertion opening to an open state or a closed state.
   [Appendix 4] The supply system according to any one of appendices 1 to 3, wherein
the first housing includes a first side on which the insertion opening is located and a second side opposite the first side, and
the at least one wheel is provided on an edge of the second side.
   [Appendix 5] The supply system according to any one of appendices 1 to 4, wherein the hydrogen module further comprises:
a cooling fan capable of cooling an interior of the first housing;
a temperature sensor capable of measuring a temperature inside the first housing; and
a controller configured to cool the interior of the first housing with the cooling fan in a case in which the temperature inside the first housing as measured by the temperature sensor exceeds a temperature threshold.
   [Appendix 6] The supply system according to appendix 5, wherein the cooling fan, the temperature sensor, and the controller are configured to operate on electric power supplied by the fuel cell module.
   [Appendix 7] The supply system according to any one of appendices 1 to 6, wherein the hydrogen module further comprises:
a hydrogen sensor capable of detecting hydrogen gas that has leaked inside the first housing; and
a controller configured to execute a notification process in a case in which hydrogen gas leaking inside the first housing is detected by the hydrogen sensor.
   [Appendix 8] The supply system according to appendix 7, wherein the hydrogen sensor and the controller are configured to operate on electric power supplied by the fuel cell module.
   [Appendix 9] The supply system according to any one of appendices 1 to 8, wherein the first housing further comprises a first handle capable of being inserted into and removed from the first housing.
   [Appendix 10] The supply system according to any one of appendices 1 to 9, wherein
the hydrogen module further comprises:
   a braking apparatus; and
   a switching valve configured to supply hydrogen gas from the hydrogen cartridge to the braking apparatus upon the first handle being inserted into the first housing, and
the braking apparatus comprises:
   a rotor attached to a rotating shaft of the wheel; and
   a pad configured to be pressed against the rotor by pressure of hydrogen gas supplied to the braking apparatus.
      [Appendix 11] The supply system according to appendix 10, wherein upon the first handle being removed from the first housing, the switching valve is configured to supply hydrogen gas inside the braking apparatus to another module connected to the first housing.
      [Appendix 12] The supply system according to any one of appendices 1 to 11, wherein the fuel cell module further comprises:
a first connector; and
a controller configured to execute an authentication process to authenticate another module upon the first connector being connected to the another module, the another module being an authorized hydrogen module in a case in which authentication of the another module is successful, wherein
in a case in which the authentication of the another module is successful, the controller is configured to receive a supply of hydrogen gas for the fuel cell module from the another module.
   [Appendix 13] The supply system according to any one of appendices 1 to 12, wherein the second housing further comprises a second handle capable of being inserted into and removed from the second housing.
   [Appendix 14] The supply system according to any one of appendices 1 to 13, wherein the fuel cell module further comprises:
a motor capable of rotating the at least one wheel of the second housing and capable of being driven by electric power generated by the fuel cell;
a sensor capable of measuring a pulling force that pulls the second housing; and
a controller configured to determine, upon the second handle being removed from the second housing, a rotation speed of the motor based on a measurement result of the pulling force measured by the sensor and rotate the motor at the determined rotation speed.
   [Appendix 15] The supply system according to appendix 14, wherein the controller is configured to stop the motor upon the second handle being inserted into the second housing.
   [Appendix 16] The supply system according to any one of appendices 1 to 15, wherein the fuel cell module further comprises:
a switch configured to start the fuel cell;
a notification interface; and
a controller configured to cause the notification interface to provide notification of whether the fuel cell has properly started.
   [Appendix 17] The supply system according to any one of appendices 1 to 16, wherein the fuel cell module further comprises:
a communication interface capable of performing short-range wireless communication; and
a controller configured to transmit information about operation of the fuel cell to a terminal apparatus of a user via the communication interface.
   [Appendix 18] The supply system according to any one of appendices 1 to 17, wherein a size of the first housing and a size of the second housing are identical.
   [Appendix 19] A hydrogen cooking system comprising:
the supply system according to any one of appendices 1 to 18 and a cooking system, wherein
the cooking system comprises:
   a first cooker capable of heating and cooking by electric power supplied by the supply system;
   a pressure reducing valve configured to reduce pressure of hydrogen gas supplied by the supply system to a predetermined pressure; and
   a second cooker capable of heating and cooking by burning hydrogen gas whose pressure has been reduced by the pressure reducing valve.
      [Appendix 20] The hydrogen cooking system according to appendix 19, wherein the cooking system further comprises a storage capable of housing the hydrogen module and the fuel cell module.
      [Appendix 21] The hydrogen cooking system according to appendix 19 or 20, wherein the cooking system further comprises:
a cooking table on which the first cooker and the second cookers are arranged; and
at least one wheel.
   [Appendix 22] The hydrogen cooking system according to any one of appendices 19 to 21, wherein
the hydrogen module comprises a plurality of hydrogen cartridges as the at least one hydrogen cartridge, and
in a case in which a remaining amount of hydrogen gas in a hydrogen cartridge, among the plurality of hydrogen cartridges, that is supplying hydrogen gas to the fuel cell module falls to or below a remaining amount threshold, and another hydrogen cartridge is filled with hydrogen gas, the hydrogen module is configured to switch the hydrogen cartridge that is supplying hydrogen gas to the fuel cell module to the another hydrogen cartridge.
   [Appendix 23] The hydrogen cooking system according to any one of appendices 19 to 22, wherein
the at least one hydrogen module in the supply system comprises a plurality of hydrogen modules,
in a case in which a remaining amount of hydrogen gas in every one of the at least one hydrogen cartridge included in the hydrogen module, among the plurality of hydrogen modules, that is supplying hydrogen gas to the fuel cell module falls to or below a remaining amount threshold, the hydrogen module that is supplying hydrogen gas to the fuel cell module is configured to transmit a signal indicating a lack of hydrogen gas to the fuel cell module, and
in a case in which the fuel cell module receives the signal indicating the lack of hydrogen gas, and another hydrogen module other than the hydrogen module that transmitted the signal is filled with hydrogen gas, the fuel cell module is configured to perform control to receive a supply of hydrogen gas from the another hydrogen module.

1. A supply system comprising:
at least one hydrogen module comprising a portable first housing and at least one hydrogen cartridge housed in the first housing, the first housing including at least one wheel; and
a fuel cell module comprising a portable second housing and a fuel cell housed in the second housing, the second housing including at least one wheel, wherein
the fuel cell module and the hydrogen module are mechanically and electrically connected, and
the fuel cell is capable of generating electric power from hydrogen gas supplied by the hydrogen module.

2. The supply system according to claim 1, wherein the first housing further includes a transparent cover.

3. The supply system according to claim 1, wherein the first housing further includes an insertion opening into which the hydrogen cartridge can be inserted and a shutter capable of switching the insertion opening to an open state or a closed state.

4. The supply system according to claim 3, wherein
the first housing includes a first side on which the insertion opening is located and a second side opposite the first side, and
the at least one wheel is provided on an edge of the second side.

5. The supply system according to claim 1, wherein the hydrogen module further comprises:
a cooling fan capable of cooling an interior of the first housing;
a temperature sensor capable of measuring a temperature inside the first housing; and
a controller configured to cool the interior of the first housing with the cooling fan in a case in which the temperature inside the first housing as measured by the temperature sensor exceeds a temperature threshold.

6. The supply system according to claim 5, wherein the cooling fan, the temperature sensor, and the controller are configured to operate on electric power supplied by the fuel cell module.

7. The supply system according to claim 1, wherein the hydrogen module further comprises:
a hydrogen sensor capable of detecting hydrogen gas that has leaked inside the first housing; and
a controller configured to execute a notification process in a case in which hydrogen gas leaking inside the first housing is detected by the hydrogen sensor.

8. The supply system according to claim 7, wherein the hydrogen sensor and the controller are configured to operate on electric power supplied by the fuel cell module.

9. The supply system according to claim 1, wherein the first housing further comprises a first handle capable of being inserted into and removed from the first housing.

10. The supply system according to claim 9, wherein
the hydrogen module further comprises:
a braking apparatus; and
a switching valve configured to supply hydrogen gas from the hydrogen cartridge to the braking apparatus upon the first handle being inserted into the first housing, and
the braking apparatus comprises:
a rotor attached to a rotating shaft of the wheel; and
a pad configured to be pressed against the rotor by pressure of hydrogen gas supplied to the braking apparatus.

11. The supply system according to claim 10, wherein upon the first handle being removed from the first housing, the switching valve is configured to supply hydrogen gas inside the braking apparatus to another module connected to the first housing.

12. The supply system according to claim 10, wherein the fuel cell module further comprises:
a first connector; and
a controller configured to execute an authentication process to authenticate another module upon the first connector being connected to the another module, the another module being an authorized hydrogen module in a case in which authentication of the another module is successful, wherein
in a case in which the authentication of the another module is successful, the controller is configured to receive a supply of hydrogen gas for the fuel cell module from the another module.

13. The supply system according to claim 1, wherein the second housing further comprises a second handle capable of being inserted into and removed from the second housing.

14. The supply system according to claim 13, wherein the fuel cell module further comprises:
a motor capable of rotating the at least one wheel of the second housing and capable of being driven by electric power generated by the fuel cell;
a sensor capable of measuring a pulling force that pulls the second housing; and
a controller configured to determine, upon the second handle being removed from the second housing, a rotation speed of the motor based on a measurement result of the pulling force measured by the sensor and rotate the motor at the determined rotation speed.

15. The supply system according to claim 14, wherein the controller is configured to stop the motor upon the second handle being inserted into the second housing.

16. The supply system according to claim 1, wherein the fuel cell module further comprises:
a switch configured to start the fuel cell;
a notification interface; and
a controller configured to cause the notification interface to provide notification of whether the fuel cell has properly started.

17. The supply system according to claim 1, wherein the fuel cell module further comprises:
a communication interface capable of performing short-range wireless communication; and
a controller configured to transmit information about operation of the fuel cell to a terminal apparatus of a user via the communication interface.

18. The supply system according to claim 1, wherein a size of the first housing and a size of the second housing are identical.

19. A hydrogen cooking system comprising:
the supply system according to claim 1 and a cooking system, wherein
the cooking system comprises:
a first cooker capable of heating and cooking by electric power supplied by the supply system;
a pressure reducing valve configured to reduce pressure of hydrogen gas supplied by the supply system to a predetermined pressure; and
a second cooker capable of heating and cooking by burning hydrogen gas whose pressure has been reduced by the pressure reducing valve.

20. The hydrogen cooking system according to claim 19, wherein the cooking system further comprises a storage capable of housing the hydrogen module and the fuel cell module.
